(19) United States
(12) Patent Application Publication
(10) Pub. No.: US 2003/0141695 A1
(43) Pub. Date: Jul. 31, 2003

(54) CHILD TRICYCLE FOLDING STRUCTURE

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/054,917

(22) Filed: Jan. 25, 2002

(51) Int. Cl. B62K 15/00

(52) U.S. Cl. 280/287

(57) ABSTRACT

A folding structure for a child tricycle comprises a handle inserted with a vertical tube into a head tube of a frame, a frame divided into a front and a rear sections pivoted together, a seat, and a shock absorber. Wherein, one end of a flexible cord is fixed in the vertical tube of the handle and another end fixed in the head tube then secured with a quick-release connector. The front section of the seat is pivoted to the front section of the frame and the rear section of the seat is connected to one end of the shock absorber while another end of the shock absorber is pivoted to the rear section of the frame. A protruding pin and a convex plate provided with a positioning hole at a rear end of the front section of the frame and correspondingly, a lateral stop and a fastener at a front end of the rear section of the frame.

### BACKGROUND OF THE INVENTION

(a) Field of the Invention

The present invention relates to a child tricycle folding structure, and more particularly, to a fast combination adapted to the tricycle with a shock absorber to reduce the tricycle size for storage and transportation.

(b) Description of the Prior Art

No folding structure for space saving has been provided for all the child tricycles generally available in the market, neither to the new generation of child tricycles. The latter is even larger in size due to the adaptation of a shock absorber and being foldable is required to reduce storage space.

### SUMMARY OF THE INVENTION

The primary purpose of the present invention is to provide a folding structure for a child tricycle. To achieve the purpose, the folding structure comprises a handle, a frame, a seat, and a shock absorber. Wherein, the handle is inserted with a vertical tube into a head tube of the frame, which is divided into a front and a rear sections pivoted together. The present invention is characterized by that one end of a flexible cord is fixed inside the vertical tube of the handle and another end of the flexible cord fixed in the head tube of the frame; the vertical tube of the handle is fixed by means of a quick-release connector; the front of the seat being pivoted to the front section of the frame and the rear section of the seat being pivoted to one end of the shock absorber; another end of the shock absorber being pivoted to the rear section of the frame; a protruding pin and a convex plate provided with a positioning hole being respectively provided at a rear end of the front section of the frame; correspondingly, a lateral stop and a fastener being separately provided in a front end of the rear section of the frame so that when the protruding pin and the lateral stop being mutually restricted, the fastener penetrating the convex panel through its positioning hole to secure to each other for use, or disengaged to fold up for storage with reduced size.

### BRIEF DESCRIPTION OF THE DRAWINGS

FIG. 1 is a locally sectional view of the present invention;

FIG. 2 is a locally perspective view (including an exploded view of the fastening) of the present invention,

FIG. 3 is a schematic view of a preferred embodiment of the present invention when folded up; and

FIG. 4 is a schematic view of another preferred embodiment of the present invention when folded up.

### DETAILED DESCRIPTION OF THE PREFERRED EMBODIMENTS

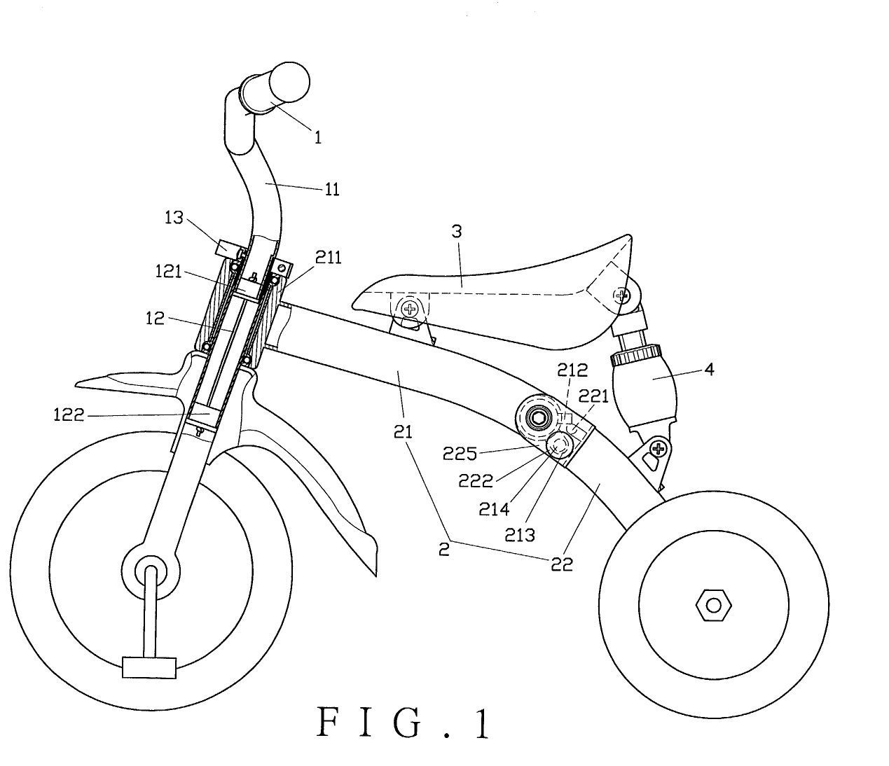

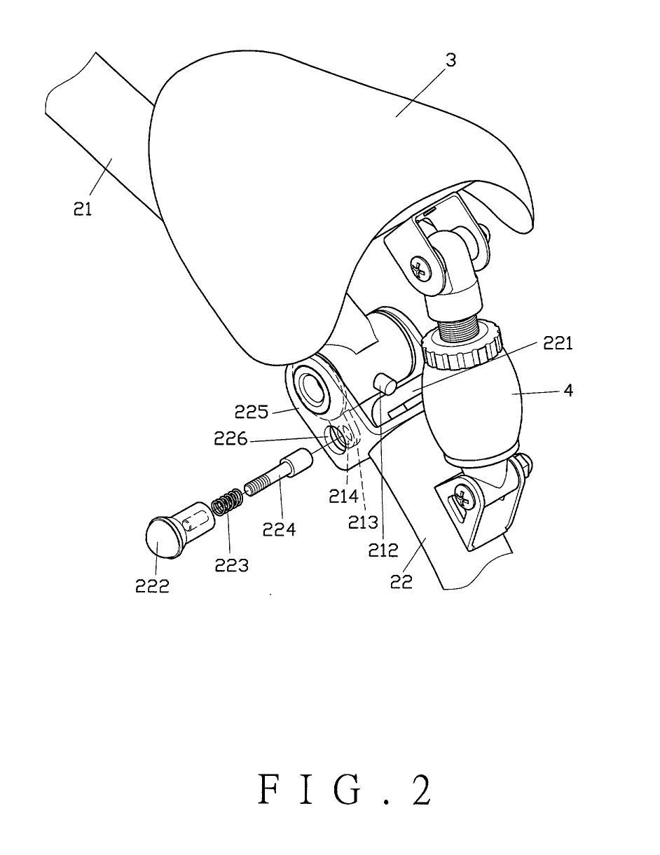

As illustrated in FIGS. 1 and 2, the present invention comprises a handle (1), a frame (2), a seat (3) and a shock absorber (4). A vertical tube (11) of the handle (1) is inserted into a head tube (211) at the front end of the frame (2), and the frame (2) is divided into a front section (21) and a rear section (22) pivoted to each other. A fixation member (121) from one end of a flexible cord (12) is fixed in the vertical tube (11) of the handle (1). Another fixing member (122) provided at the other end of the flexible cord (12) is fixed in the head tube (211) of the frame (2). A quick-release connector (13) is provided to the vertical tube (11) of the handle (1) for holding the handle (1) in position. The front end of the seat (3) is pivoted to the front section (21) of the frame. The rear section of the seat (3) is pivoted to one end of the shock absorber (4) while the other end of the shock absorber (4) is pivoted to the rear section (22) of the frame (2). A protruding pin (212) and a convex panel (213) having a positioning hole (214) are separately provided to the rear end of the front section (21) of the frame (2). A lateral stop (221) and a fastener (222) are provided to the front end of the rear section (22) of the frame (2). The fastener (22) is inserted by means of a bolt (224) through a hole (226) in a U-shaped bracket (225) at the front end of the rear section (22) of the frame (2), then into a spring (223) to be engaged to the fastener (222). Both of the protruding pin (212) and the lateral stop (221) restrict each other to allow the fastener (222) to penetrate through the positioning hole (214) of the convex plate (213) to complete the assembly.

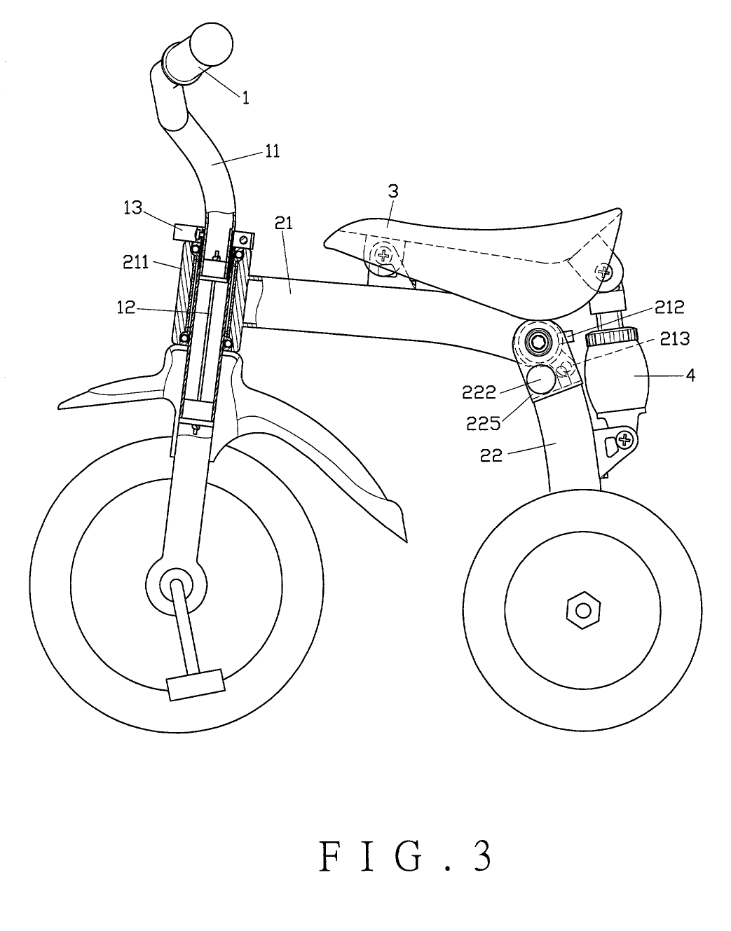

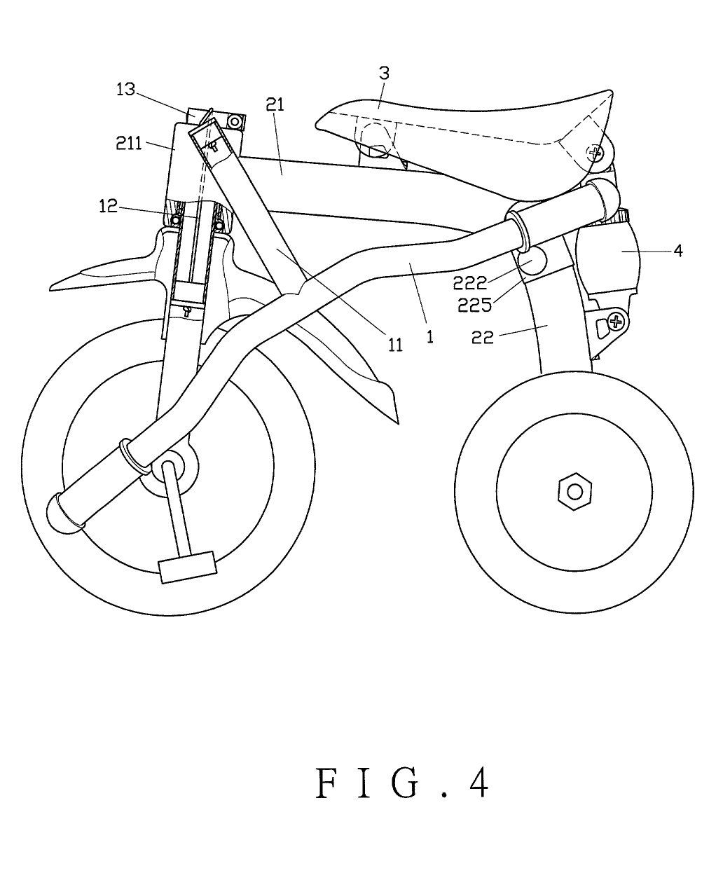

To fold up, as illustrated in FIGS. 3 and 4, the quick-release connector (13) is released, and the fastener (222) is pulled out to free the bolt (224) from the positioning hole (214) of the convex plate (213). Then the handle (1) is pulled out and folded up together with the rear section (22) of the frame (2) to reduce the size of the tricycle for storage.

As disclosed, the present invention permits easier operation simply by one hand to be set up for use and released for storage in reduced size.

I claim:

1. a child tricycle folding structure comprising a handle, a frame, a seat, and a shock absorber; wherein, said handle being inserted with a vertical tube into a head tube of said frame and said frame being divided into a front and a rear sections pivoted together; characterized by that:
one end of a flexible cord being fixed inside said vertical tube of said handle and another end of said flexible cord fixed in said head tube of said frame; said vertical tube of said handle being fixed by means of a quick-release connector; a front section of said seat being pivoted to said front section of said frame; a rear section of said seat being pivoted to one end of said shock absorber; another end of said shock absorber being pivoted to said rear section of said frame; a protruding pin and a convex plate having a positioning hole being respectively provided at a rear end of said front section of said frame; a lateral stop and a fastener being separately provided in a front end of said rear section of said frame; said protruding pin and said lateral stop being mutually restricted, and said fastener penetrating through said positioning hole of said convex panel to secure to each other.
